(19) United States
(12) Patent Application Publication
(10) Pub. No.: US 2008/0089371 A1
(43) Pub. Date: Apr. 17, 2008

(54) Bright light source with two-dimensional array of diode-laser emitters

(76) Inventor: Patrick Reichert, Dublin, CA (US)

Correspondence Address: STALLMAN & POLLOCK LLP, 353 SACRAMENTO STREET, SUITE 2200, SAN FRANCISCO, CA, 94111, US

(21) Appl. No.: 11/546,227

(22) Filed: Oct. 11, 2006

(51) Int. Cl. H01S 3/04

(52) U.S. Cl. 372/34

(57) ABSTRACT

A bright light-source includes four diode-laser bars stacked on another in the fast-axis direction. Each of the diode-laser bars has a substrate side and an expitaxial side. In one example of the light-source, the diode-laser bars are soldered together with the epitaxial side of one soldered to the substrate side of another such that the bars are and connected electrically in series.

### TECHNICAL FIELD OF THE INVENTION

The present invention relates in general to light sources including diode-laser bars. The invention relates in particular to light sources including diode-lasers bars vertically stacked to provide a two-dimensional array of diode-laser emitters.

### DISCUSSION OF BACKGROUND ART

Diode-lasers (edge-emitting semiconductor-lasers) provide an efficient source of bright light. Electrical to optical efficiency can be as high as 50%. This high efficiency makes diode-lasers attractive as laser radiation sources in applications such as photo-initiators, illuminators, and solid state laser pump sources, to name a few. An individual diode-laser typically has a stripe length (resonator length) between about 0.6 millimeter (mm) and 2.5 mm. Light is emitted from an aperture that has a height of between about 1.0 micrometers (μm) and 2.0 μm and a width depending on the output power required from the individual diode laser, with the width being greater as more optical power is required. This width can be as large as 200 μm. The height and width directions of the emitting aperture are usually termed the fast and slow axes, respectively, by practitioners of the art. When more power is required than one emitting aperture can supply, it is usual commercial practice to provide a linear array of emitting apertures, commonly referred to as a diode-laser bar. In such an array, a plurality of diode-lasers (emitters) are formed on a single substrate (the “bar”). This provides that the emitting apertures of the emitters are aligned in the slow axis direction. A diode-laser bar usually has a length of about 10.0 mm.

One approach to providing a diode-laser source that has more power than a single diode-laser bar is to provide a plurality of diode-laser bars stacked one above the other, i.e., in the fast axis direction, to provide a two-dimensional array of diode-laser emitters. In such an array the brightness of the array as a light source increases the closer the bars are together in the fast axis, among other factors. Over a period of more than 15 years many designs have been proposed for stacked arrays of diode-laser bars. Examples of such designs are found in U.S. Pat. Nos. 5,040,187; 5,099,488; 5,105,429; 5,835,515; 5,835,518; 5,909,458; 6,352,873; and 7,060,515 all of which are incorporated herein by reference.

While at least certain aspects of each of these designs have been found to be separately inventive, the designs all require that each diode-laser bar in the stack be separately cooled. In each case, there is a cooling-member between adjacent diode-laser bars, even though in certain instances, for example in the '187 patent, the individual cooling-members are monolithically part of a larger, common cooling-member. The need for an individual cooling-member between the bars limits the fast-axis proximity that the bars can have, and, accordingly, the brightness of the source.

In acceptance of this, designs have been proposed in which an optical arrangement, such as a waveguide array or a prismatic device, is used to bring beams from the fast-axis stacked and spaced-apart bars into a closer proximity than the bar stacking. Such arrangements are to be found, for example, in U.S. Pat. Nos. 6,151,342; 6,229,831; 6,993,059; and 7,006,549, each thereof assigned to the assignee of the present invention, all of which are incorporated herein by reference.

The use of any optical device of any kind for improving the brightness of a light-source based on a prior-art fast-axis-stacked diode-laser bar array adds cost and complexity to the light source. It would therefore be advantageous if an improvement in the source brightness could be realized without such an optical device.

### SUMMARY OF THE INVENTION

The present invention is directed to providing a bright light-source including a plurality of diode-laser bars. In one aspect a light-source in accordance with the present invention comprises a plurality of diode-laser bars vertically stacked and bonded together.

In a preferred embodiment of the invention each of the diode-laser bars has a substrate side and an epitaxial side, and the substrate side of all but a first of the diode-laser bars is bonded and electrically connected to the epitaxial side of an adjacent one of the diode-laser bars. This provides that the diode-laser bars are electrically connected together in series. The diode-laser bars are stacked between and in electrical and thermal contact with first and second end-plates of a thermally conductive material. The end plates in turn are in thermal contact with a common heat sink.

In another aspect of the present invention the light-source comprises a plurality of light-source modules with each module including a plurality of diode-laser bars vertically stacked and bonded together and held between thermally conductive end plates. The modules are arranged such that the pluralities of stacked diode-laser bars therein are aligned in the fast-axis direction of the diode-laser bars.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 is a three-dimensional view schematically illustrating one preferred embodiment of a light-source in accordance with the present invention in the form of a light-source module including four diode-laser bars stacked one above the other in the fast-axis direction, bonded together and electrically connected, and held between first and second cooling members in thermal contact therewith, with the first and second cooling-members being in thermal contact with a common third cooling-member.

FIG. 2 is a fragmentary three-dimensional view schematically illustrating details of bonding and a series electrical connection of the diode-laser bars, connection of the first and second cooling members to the diode-laser bars, and bonding of the first and second cooling-members to the third cooling-member.

FIG. 3 is a three-dimensional view schematically illustrating another preferred embodiment of a light-source in accordance with the present invention including four of the light-source modules of FIG. 1 stacked one above the other in the fast-axis direction, electrically connected in series, and with common third cooling-members of each module attached to a common base.

FIG. 4 is a graph schematically illustrating computed fast-axis laser intensity distribution for the light source depicted in FIG. 3 at three distances from the source along the propagation axis of light emitted from the source.

FIG. 5 is a graph schematically illustrating computed slow-axis laser intensity distribution for the light source depicted in FIG. 3 at three distances from the source along the propagation axis of light emitted from the source.

### DETAILED DESCRIPTION OF THE INVENTION

The present invention is based on a discovery that for pulsed operation of a vertical stack of diode-laser bars with a sufficiently low duty cycle, for example less than about 2 percent, and stacks divided into sufficiently small sub-modules, it is not absolutely necessary to provide a separate cooling surface for each diode laser bar. This allows some number of diode-laser bars to be stacked directly one above the other to minimize fast axis separation of emitters in the bars. The maximum duty cycle and the number of bars that can be directly stacked depends on the peak and average optical power of each diode-laser bar, the required heat sink temperature and the allowable wavelength spread across the sub-module, among other factors, as will be evident from the detailed description of the present invention set forth below.

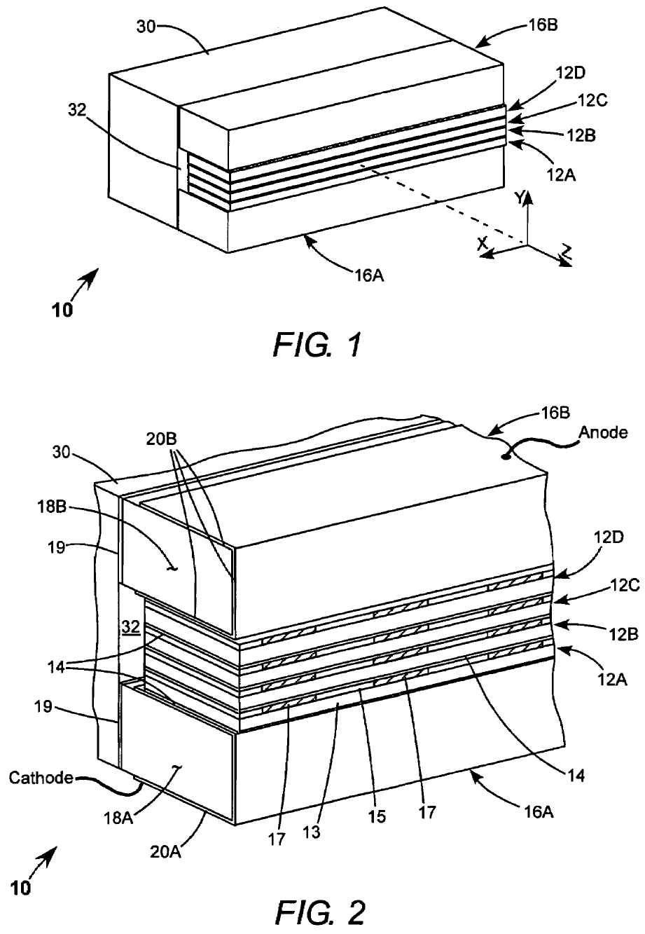

Referring now to the drawings, wherein like components are designated by like reference numerals, FIG. 1 and FIG. 2 schematically illustrate one preferred embodiment 10 of a light-source module in accordance with the present invention. Module 10 includes four diode-laser bars 12 (designated 12A, 12B, 12C and 12D) stacked one above the other in the fast-axis direction. The fast axis here is designated arbitrarily as the Y-axis, the slow axis, perpendicular to the fast-axis, is correspondingly designated as the X-axis, and the propagation axis of light from the diode-laser bars (perpendicular to both the X- and Y-axes) is designated as the Z-axis. In prior art diode-laser bar arrays aligning the diode-laser bar arrays in the fast axis direction, not bonded together, is often referred for convenience of description as “vertical” stacking with the term vertical here not being necessarily applicable to an instant orientation of the array of bars.

In the inventive stacking arrangement, the “vertically-stacked” diode-laser bars are bonded together and electrically connected. The stacked, bonded and electrically connected diode-laser bars are held between lower and upper cooling-members or end-plates 16A and 16B in thermal and electrical contact therewith. Cooling-members 16A and 16B are in thermal contact with a common, third cooling-member or heat-sink 30, preferably a metal heat-sink. It should be noted here that the terminology “upper and lower” as opposed to cooling-members 16A and 16B is used here simply for convenience of description, and should not be construed as implying that module 10 is intended for use exclusively in the orientation depicted.

Referring in particular to FIG. 2, in a preferred method of electrically connecting diode-laser bars 12A-D, the diode-laser bars are electrically connected in series. Each of the diode-laser bars includes a substrate portion 13 and an epitaxial layer (epitaxial) portion 15 in which individual emitters 17 are defined. Substrate portion 13 preferably has a thickness of between about 100 micrometers (μm) and 300 μm. A particularly common substrate thickness for diode-laser bars is 135 μm. The thickness of the epitaxial portion is usually about 5 μm. The diode-laser bars are preferably bonded together by a layer 14 of a solder such as Gold Tin (AuSn) or Indium (In) solder that provides electrical connection in addition to bonding. Such a solder layer will usually have a thickness of about 5-12 μm. The diode-laser bars are bonded with the substrate portion (substrate side) of diode-laser bar 12B bonded to the epitaxial portion (epitaxial side) of diode-laser bar 12A, the substrate side of diode-laser bar 12C bonded to the epitaxial side of diode-laser bar 12B, and the substrate side of diode-laser bar 12D bonded to the epitaxial side of diode-laser bar 12C.

Lower and upper cooling members 16A and 16B are preferably formed from plates, respectively 18A and 18B of a thermally conductive dielectric material. Beryllium oxide is a preferred such material, but other materials such as diamond or alumina may be used without departing from the spirit and scope of the present invention. Plates 18A and 18B are partially coated with a metallization layer respectively 20A and 20B. Each metallization layer extends partially over an upper surface of the cooling member-body, over a front surface of the plate, and partially over a lower surface of the plate. Substrate side 13 of diode-laser bar 12A is bonded and electrically connected to metallization layer 20A of cooling member 16A. Epitaxial side 15 of diode-laser bar 12D is bonded and electrically connected to metallization layer 20B of cooling, member 16B. Metalization layers 20A and 20B provide, respectively, cathode and anode connections for module 10.

Each of the upper and lower cooling members is bonded by a solder layer 19 to, and in thermal communication with, heat-sink 30 of module 10. In this particular stacking arrangement there is a gap 32 between the diode-laser bars and heat-sink 30. This gap can optionally be filled with an electrically nonconductive, thermally conductive gel to improve heat extraction from the stacked diodes. One suitable gel is a type DP100 gel available from Geltech Inc., of Orlando, Fla. However, thermal analysis calculations of an example of light-source module 10 indicate that the primary thermal path from the diode is in the Y-axis direction (plus or minus) from about the center plane of the bar-stack to the upper and lower cooling members.

By way of example, in one calculation in which it was assumed that a bonded stack of four diode-laser bars, each having a power output of 100 Watts (W), and a thickness of about 140 μm was operated at a 1% duty cycle, there was only about 2° K difference between the temperature at the center of the diode-laser bar stack and the temperature at the interfaces between the diode-laser bar stack and the cooling members. Clearly, however, if more bars were stacked, or the duty cycle extended, this temperature difference could be expected to increase.

Those skilled in the art will recognize that certain variations in material and bonding of components of module 10 are possible. By way of example, a conductive epoxy may be used instead of solder for forming electrically conductive bonds between the diode-laser bars and the end plates. Cooling members 16A and 16B may be made from a metal or a metal alloy, for example, Copper-Tungsten (Cu—W). In this case, however, it would be necessary to provide electrical insulation between these cooling members and heat sink 30. Different means could be used to make external electrical connection to the cooling members. These and similar variations may be made without departing from the spirit and scope of the present invention.

It is preferable that, whatever material cooling members 16A and 16B are made from, the material has a thermal expansion coefficient close to that of the diode-laser bar substrate material. Beryllium oxide and Cu—W have a thermal expansion coefficient similar to that of Gallium Arsenide (GaAs) which is the usual substrate material of diode-laser bars having an emitting wavelength between about 700 nanometers (nm) and about 1000 nm.

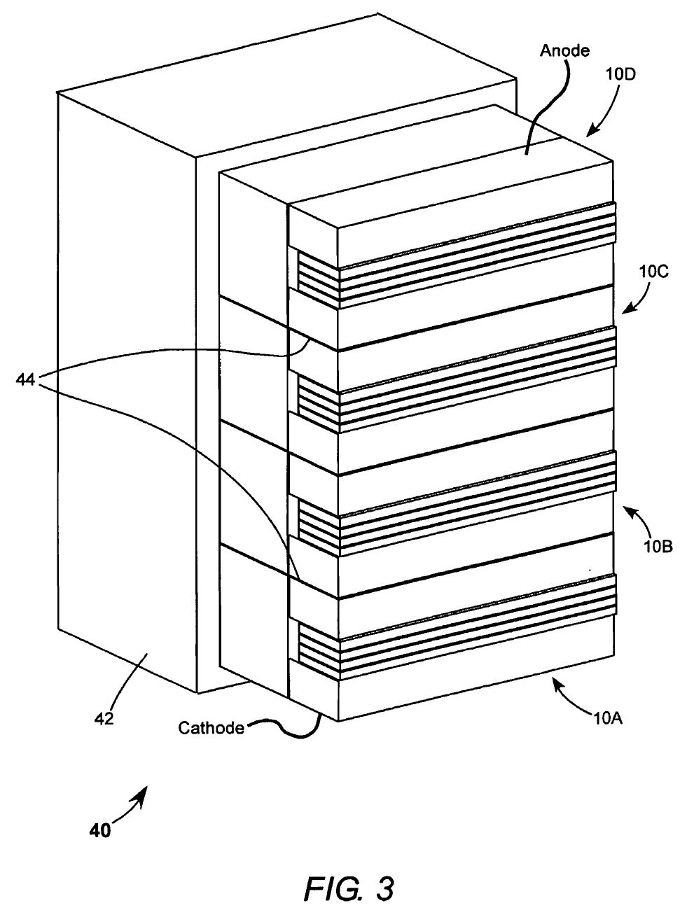

FIG. 3 schematically illustrates another embodiment 40 of a light-source in accordance with the present invention. Light source 40 includes a plurality of light-source modules 10, stacked one above the other in the fast axis direction. The heat-sink 30 of each module is attached to a base plate 42. This provides that light source 40 includes four groups of 4 directly stacked diode laser bars spaced apart in the fast axis direction by twice the thickness of a cooling-member (end-plate) 16. By electrically connecting adjacent cooling members 16 together, for example via solder layers 44, all sixteen diode-laser bars can be connected is series with outermost ones of the end-plates providing anode and cathode connections for the light source as depicted. Those skilled in the art will recognize that other heat sink arrangements, including prior-art heat-sink arrangements, may be adapted to support the plurality of groups of vertically-stacked bars spaced-apart in the fast-axis direction without departing from the sprit and scope of the present invention.

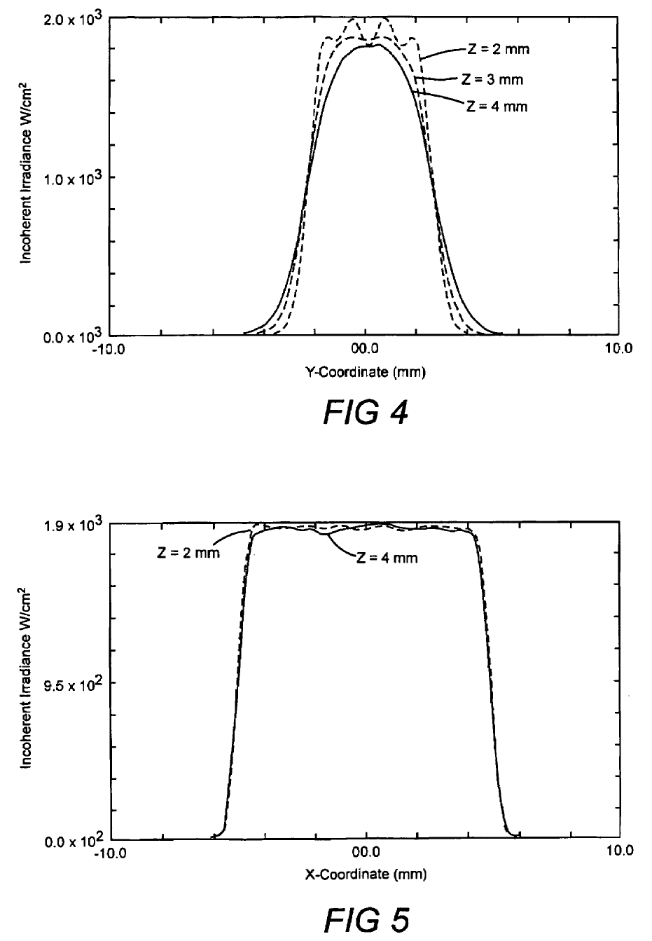

FIG. 4 is a graph schematically illustrating computed fast-axis distribution of incoherent irradiance (intensity) in an example of the light-source of FIG. 3 at distances of 2.0 mm, 3.0 mm, and 4.0 mm from the light-source along the propagation axis of light emitted from the source. In the example, it was assumed that there were four groups of four 100 W diode-laser bars, with the groups being spaced apart in the fast axis by about 800 μm from the uppermost bar in one group to the lowermost bar in an adjacent group. It was assumed that the total thickness of diode-laser bars in a group was 140 μm with solder layers 14 being 12 μm thick, i.e., the emitter arrays of the bars were fast-axis spaced by 152 μm (center to center). It was also assumed that emitters in the bars had an aperture width of 150 μm and were spaced apart in the slow-axis (center to center) by 167 μm.

FIG. 5 is a graph schematically illustrating computed slow-axis intensity distribution of the above discussed an example of the light source of FIG. 3 at distances of 2.0 mm and 4.0 mm from the light-source along the propagation axis of light emitted from the source. It can be seen that the distribution is essentially uniform at both distances.

Those skilled in the art will recognize that the embodiments of the present invention discussed above are not the only possible embodiments and may devise other embodiments without departing from the spirit and scope of the present invention. Those skilled in the art will also recognize that while a light-source in accordance with the present invention having multiple spaced-apart groups of directly-stacked diode-laser bars may have a high-brightness, the brightness of such a source could be improved by an optical arrangement for providing fast-axis spacing between beams from the diode-laser bars that is closer than the fast-axis spacing of emitter arrays of the diode-laser bars.

In summary, the present invention is described above in terms of a preferred and other embodiments. The invention is not limited, however, to the embodiments described and depicted. Rather, the invention is limited only by the claims appended hereto.

What is claimed is:

1. A light-source comprising:
a plurality of diode-laser bars vertically stacked and directly bonded together.

2. The light-source of claim 1, wherein each of the diode-laser bars has a substrate side and an epitaxial side, and wherein the substrate side of all but a first of the diode-laser bars is bonded and electrically connected to the epitaxial side of an adjacent one of the diode-laser bars, whereby the diode-laser bars are electrically connected together in series.

3. The light-source of claim 2, wherein the diode-laser bars are stacked between and in electrical and thermal contact with first and second end-plates of a thermally conductive material.

4. The light-source of claim 3, wherein the end-plates are made from a metal.

5. The light-source of claim 3, wherein the end plates are made from a thermally conductive dielectric material and a portion of the dielectric material is provided with a metal layer to facilitate electric contact with the end plates.

6. The light source of claim 3, wherein the end-plates are in thermal communication with a common heat-sink.

7. A light-source, comprising:
a plurality of diode-laser bars, each thereof having a fast axis and a slow axis, the diode-laser bars being aligned with each other in the slow axis direction and stacked together in the fast-axis direction with each one directly bonded to another.

8. The light-source of claim 7, wherein there are four diode-laser bars stacked together in the fast-axis direction with each one bonded to another.

9. The light-source of claim 7, wherein each of the diode-laser bars has a substrate side and an epitaxial side, and wherein the substrate side of all but a first of the diode-laser bars is bonded and electrically connected to the epitaxial side of an adjacent one of the diode-laser bars, whereby the diode-laser bars are electrically connected together in series.

10. The light-source of claim 9, wherein the diode-laser bars are stacked between and in electrical and thermal contact with first and second end-plates of a thermally conductive material.

11. The light-source of claim 10, wherein the end-plates are made from a metal.

12. The light-source of claim 10, wherein the end plates are made form a thermally conductive dielectric material and a portion of the dielectric material is provided with a metal layer to facilitate electric contact with the end plates.

13. The light source of claim 10, wherein the end-plates are in thermal communication with a common heat-sink.

14. A light-source comprising a plurality of diode-laser bars vertically stacked and bonded to each other without a heat sink material therebetween.

15. A light-source comprising a plurality of diode-laser bars vertically stacked and directly connected with only a bonding material therebetween.

16. A light-source comprising:
a diode laser bar stack including a plurality of diode-laser bars each having a substrate side and an epitaxial side, and wherein the substrate side of all but a first of the diode-laser bars are electrically connected to the epitaxial side of an adjacent one of the diode-laser bars with only a bonding material therebetween, whereby the diode-laser bars are electrically connected together in series and wherein the diode-laser bars are stacked between and in electrical and thermal contact with first and second end-plates formed from a thermally conductive material.

17. A light-source comprising:
a series of at least two diode laser bar stacks, each diode laser bar stack including a plurality of diode-laser bars each having a substrate side and an epitaxial side, and wherein the substrate side of all but a first of the diode-laser bars is directly bonded and electrically connected to the epitaxial side of an adjacent one of the diode-laser bars, whereby the diode-laser bars are electrically connected together in series and wherein the diode-laser bars are stacked between and in electrical and thermal contact with first and second end-plates formed from a thermally conductive material, said diode laser bar stacks being stacked upon one another with a first end-plate of one diode laser bar stack being bonded to the second end plate of the another diode laser bar stack.

18. The light source of claim 17, wherein the end-plates are in thermal communication with a common heat-sink.
